(19) United States
(12) Patent Application Publication
(10) Pub. No.: US 2010/0328466 A1
(43) Pub. Date: Dec. 30, 2010

(54) INFRARED ILLUMINATOR WITH VARIABLE BEAM ANGLE

(75) Inventors: Bulent EREL, Roswell, GA (US); Chris W. HARDEN, Griffin, GA (US); Virgil L. HUNT, Snellville, GA (US); Peter G. SCHNEIDER, Decatur, GA (US); Raymond V. PAGANO, Stone Mountain, GA (US); James L. PFAFFENBERGER, Marietta, GA (US)

Correspondence Address: GARDNER GROFF GREENWALD & VILLANUEVA. PC, 2018 POWERS FERRY ROAD, SUITE 800, ATLANTA, GA, 30339, US

(73) Assignee: VIDEOLARM, INC., Decatur, GA (US)

(21) Appl. No.: 11/933,599

(22) Filed: Nov. 1, 2007

Related U.S. Application Data
(60) Provisional application No. 60/863,912, filed on Nov. 1, 2006.

(51) Int. Cl. H04N 5/33; G01J 3/10; F21S 4/00; H05B 37/02

(52) U.S. Cl. 348/164; 250/504 R; 362/249.1; 315/294; 348/E05.09

(57) ABSTRACT

An infrared illuminator including at least two carrier members in angularly adjustable relation with respect to one another, each carrier member having at least one infrared light source mounted thereto, for projecting infrared light in a variable illumination pattern. The illuminator may also include at least one fan for cooling the light sources, and a housing for containing the light sources. The carrier members are positionally adjustable such that the width, range, and/or intensity of the light projected by the illuminator can be varied depending on the desired application.

### CROSS-REFERENCE TO RELATED APPLICATION

This application claims the priority benefit of U.S. Provisional Patent Application Ser. No. 60/863,912, filed Nov. 1, 2006, which is hereby incorporated herein by reference in its entirety for all purposes.

### TECHNICAL FIELD

The present invention relates generally to illuminators and more particularly, to a variable beam angle infrared illuminator used in conjunction with infrared image capturing and surveillance technology.

### BACKGROUND OF THE INVENTION

Infrared cameras are able to acquire images in low or almost no light circumstances. Therefore, infrared cameras have long been used in the fields of night-vision systems, surveillance, military operations, and wildlife photography. In many instances, an infrared illuminator is used in combination with such cameras to project infrared light on a target area to successfully capture an image. The infrared light projected by the illuminator is reflected back from objects in the target field and then captured by the camera.

Known infrared illuminators, however, are not as versatile as might be desired, and often require a user to purchase and install different types of illuminators to provide different illumination field widths and/or ranges to satisfy a particular application. For example, separate infrared illuminators may provide 30-degree, 45-degree, or 60-degree field widths. If a user wishes to vary the field width or illumination range, a different type of illuminator must be provided. This is often not feasible or practical and can lead to inefficiencies and/or less than optimal illumination performance. Also, distributors, sellers and/or installers may need to stock multiple types of illuminator units for applications requiring different fields and/or ranges of illumination, which can result in availability problems and inefficiencies.

Thus it can be seen that needs exist for continuing improvement in the field of illumination. It is to the provision of an illuminator meeting these needs and others that the current application is primarily directed.

### SUMMARY OF THE INVENTION

In example embodiments, the present invention is an infrared illuminator including at least two infrared light sources for projecting infrared light and at least two faceplates carrying the light sources thereon. The illuminator also includes at least one fan for cooling the light sources and a housing for containing the light sources and at the least one fan. One or more of the faceplates are angularly adjustable in relation to the other(s), such that the beam angle and range of the infrared light projected by the at least two light sources can be selectively varied by user adjustment. As a result, the illuminator of the present invention is adaptable to applications requiring different ranges and fields of illumination, without the need for a plurality of illuminators. In example forms, the beam angle of the illuminator's output can vary from 30° to 45° to 60°, to encompass a wide range of applications.

In another aspect, the present invention is an infrared illuminator including a fixed panel and a pivoting panel. The fixed panel includes at least one light source mounted thereon and the pivoting panel is hingedly connected to the fixed panel and has at least one light source thereon.

In another aspect, the present invention is an illuminator including a fixed panel having at least one light source mounted thereon, and a pivoting panel hingedly connected to the fixed panel and having at least one light source mounted thereon.

In still another aspect, the present invention is an infrared illuminator including a housing, a first panel, and a second panel. The first panel is mounted to the housing and includes a first plurality of infrared LED's mounted thereon. The second panel is hingedly connected to one side of the first panel and includes a second plurality of infrared LED's mounted thereon.

In another aspect, the present invention is an infrared illuminator including a first member having a first infrared light source mounted thereto, a second member having a second infrared light source mounted thereto and being positionally adjustable relative to the first member, and a housing for containing the first and second members.

In yet another aspect, the present invention is an infrared illuminator including a housing, a first panel mounted within that housing and having a first plurality of infrared LEDs mounted thereon, and a second panel hingedly connected to one side of the first panel and having a second plurality of infrared LEDs mounted thereon.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of an illuminator according to an example embodiment of the present invention.

FIG. 2 shows the illuminator of FIG. 1 with its housing opened and internal components partially withdrawn from the housing.

FIG. 3 is a rear perspective view of internal components of the illuminator of FIG. 1 shown removed from the housing.

FIG. 4a shows internal components of the illuminator of FIG. 1 adjusted to a 60° beam angle of illumination.

FIG. 4b shows internal components of the illuminator of FIG. 1 adjusted to a 30° beam angle of illumination.

FIG. 5a is an external view showing adjustment of the illuminator of FIG. 1 to a 60° beam angle of illumination.

FIG. 5b is an external view showing adjustment of the illuminator of FIG. 1 to a 30° beam angle of illumination.

FIG. 6a is a light pattern showing the field of illumination of an example embodiment of an illuminator according to the present invention, at a 60° beam angle.

FIG. 6b is a light pattern showing the field of illumination of an example embodiment of an illuminator according to the present invention, at a 30° beam angle.

FIG. 7 shows an illuminator according to another form of the present invention incorporating an onboard surveillance camera.

FIG. 8 is a rear perspective view of internal components of the illuminator of FIG. 7, shown removed from the housing.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

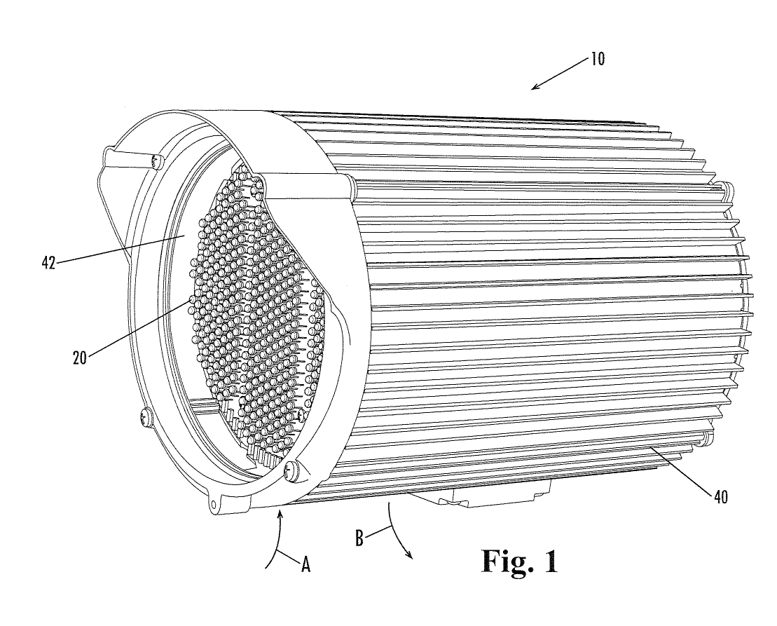

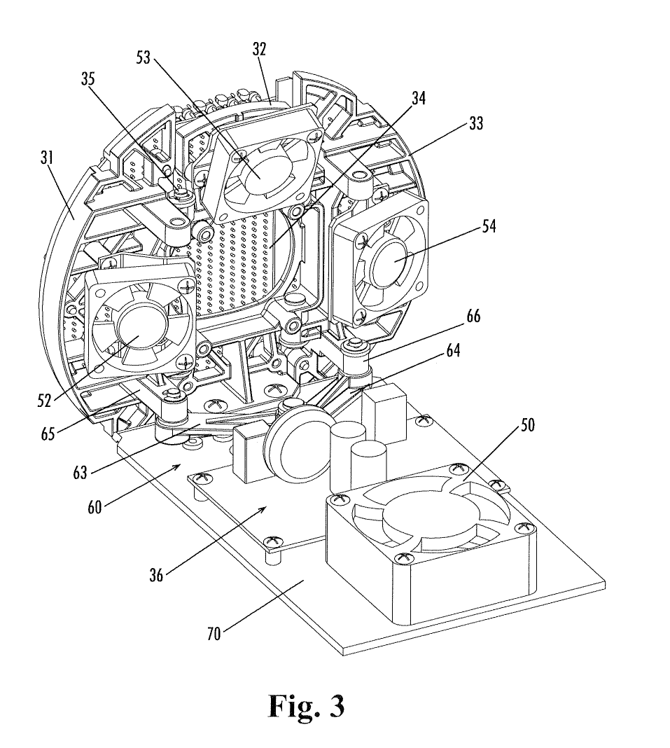

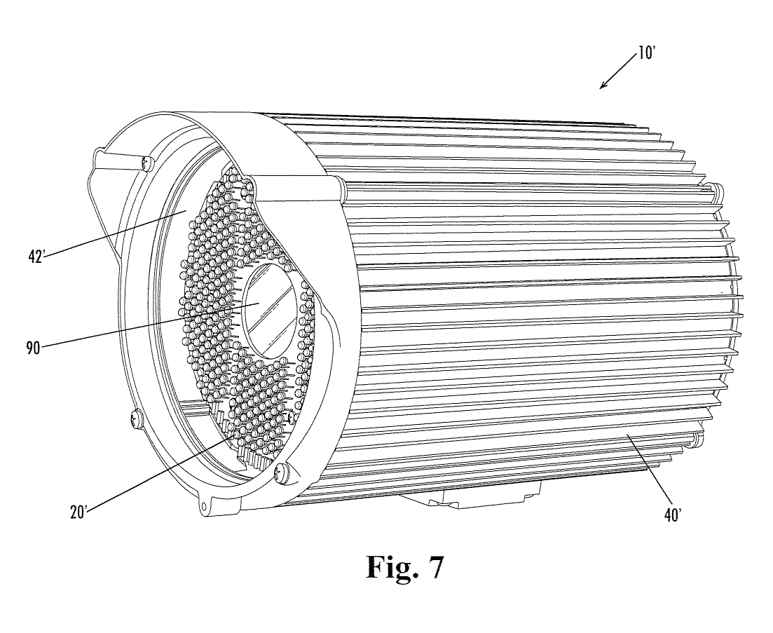

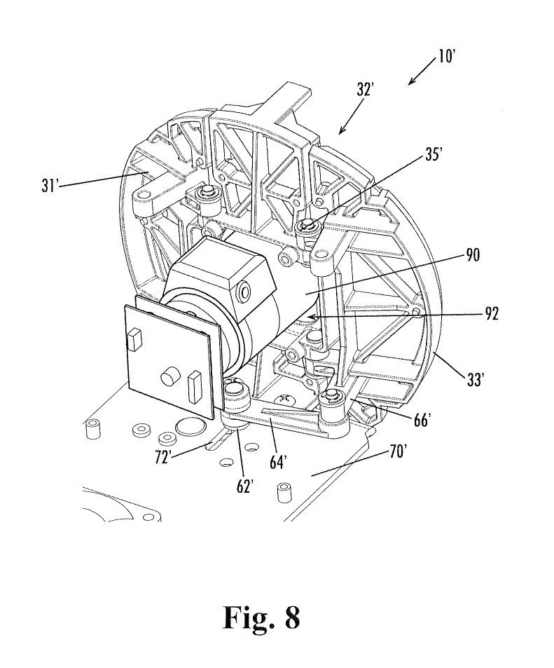

With reference now to the drawing figures, FIGS. 1-8 depict an illuminator 10, 10′ according to example embodiments of the present invention. The illuminator 10, 10′ of the present invention illuminates a field with light and optionally includes an on-board camera (shown in the embodiment of FIGS. 7 and 8, described below) for capturing both still and/or moving images, for example, for display and/or recording in remote surveillance applications. Alternatively or additionally, a separate camera is used in combination with the illuminator.

In example embodiments, the illuminator 10 utilizes one or more light sources that only project wavelengths of light in the infrared (IR) spectrum (750 nm-1 mm), and not emitting light in the visible spectrum (roughly 400-700 nm), for use in combination with a camera suited for capturing images illumined with infrared light. In other embodiments, the illuminator 10 can emit both infrared and visible light, visible light only, and/or light of other wavelengths. The illuminator 10 comprises at least two light sources, wherein at least one light source is mounted to each of two or more carriers or faceplates, at least one of which is positionally adjustable relative to another to vary the range and/or field of illumination. In the depicted embodiment, a plurality of infrared light emitting diode (LED) light sources 20 are mounted to each of three faceplates 31, 32, 33. In alternative embodiments, other infrared and/or visible light sources such as floodlights, spotlights, or other types of lighting arrangements can be used in place of, or in conjunction with, the LEDs 22. The LEDs are preferably spaced apart from each other on the faceplates at distances that provide suitable performance, depending on factors such as the required application of the illuminator, the intensity of the LEDs, and amount of heat generated by such. In example embodiments, the LEDs are spaced apart from each other, both horizontally and vertically, at distances of approximately 0.085 inches.

The illuminator 10 further comprises a housing 40 for receiving the faceplates or carriers 31, 32, 33 and light sources 20 therein, and at least one fan 50 for cooling the illuminator and its components by delivery of targeted cooling air flow(s) through and within the housing. The illuminator 10 further comprises an illumination angle adjustment mechanism 60 for adjusting the position of one or more faceplates relative to one another, which is described in greater detail below. The LEDs 20 or other light sources are connected to electronic panel portions 34 of each of the faceplates 31, 32, 33, and are powered and controlled by electronics 36 on a circuit board mounted to a mounting plate 70 within the housing 40. Optionally, the control circuitry 36 includes a switch or other electronic power controller for varying the current and/or the voltage delivered to the light sources to provide two or more power settings (such as high, medium, and low) for additional control of the range or intensity of illumination delivered. The mounting plate 70 is preferably slidably or otherwise retractably mounted within the housing 40 for access during maintenance or installation.

In the depicted embodiment, two adjustable outer faceplates (31, 33) are pivotally connected to a fixed center faceplate 32 for varying the output direction of the infrared light generated by light sources on the respective faceplates, and thereby varying the beam angle of illumination. In example embodiments, four hinges 35 (two per side) connect the outer faceplates to the center faceplate, and enable pivotal movement of the outer faceplates in relation to the center faceplate (in alternate embodiments, more or fewer hinges or other couplings can be utilized). Also, while the depicted embodiments comprise angularly adjustable side faceplates for varying the horizontal field of illumination, the invention likewise includes embodiments having adjustable top and/or bottom faceplates for varying the vertical field of illumination. In various alternative forms of the invention, one or more fixed faceplate(s) are provided with one, two, three or more adjustable faceplates positioned in angularly adjustable relation thereto. For example, a central faceplate may be provided with four outer faceplates, one hingedly attached at the top, bottom, left and right edges of the central faceplate. Alternatively, two or more adjustable faceplates may be provided without a fixed faceplate, for example in the form of first and second pivoting faceplates connected on either side of a central hinge.

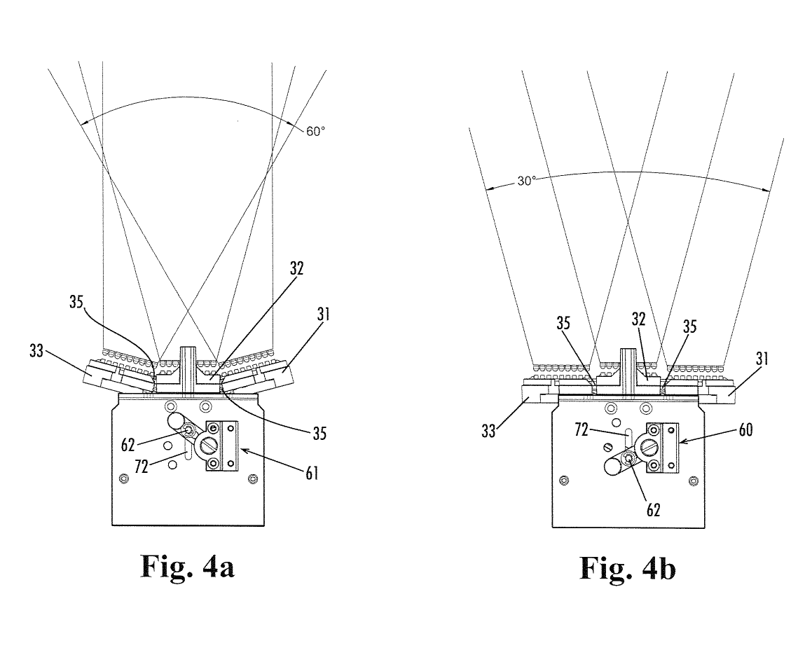

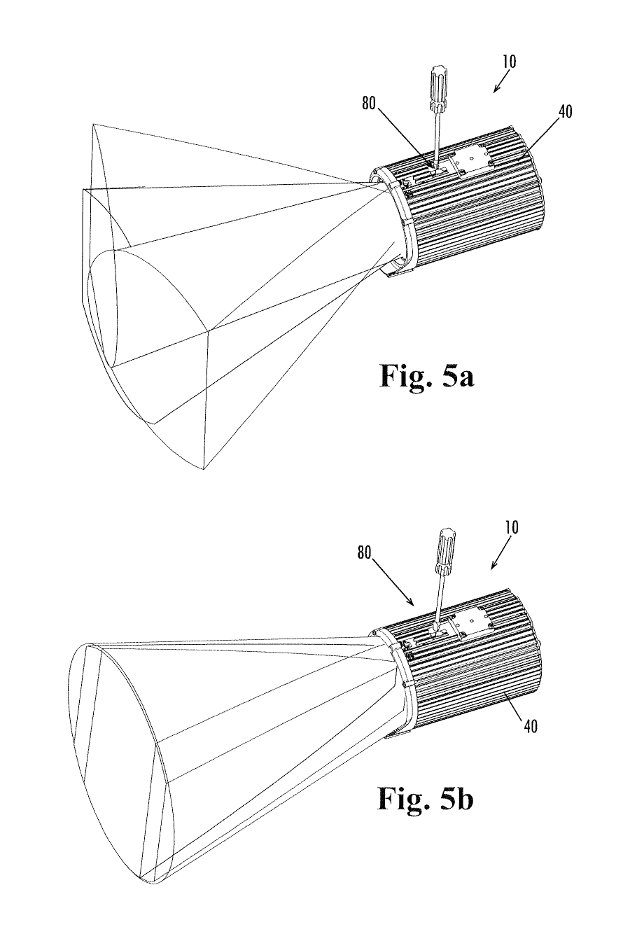

The illuminator 10 further comprises a faceplate position adjustment mechanism 60 enabling angular adjustment of the outer faceplates (31, 33) relative to the center faceplate 32, preferably from outside of the housing 40. For example, as seen best with reference to FIGS. 4 and 5, the present invention eliminates the need for different infrared illuminators of differing ranges or output patterns, by enabling user adjustment of the beam angle of the infrared light output to vary the width or field, the range, and/or the intensity of the illumination provided. Example embodiments of the present invention allow a user to adjust the output beam angle of the infrared illumination between about 30 degrees and about 60 degrees. For example, for LEDs 20 having a natural field angle of 30°, it has been found that a 60° spread or beam angle (FIGS. 4a and 5a) allows for suitable illumination of a wider field, a lower illumination intensity, and/or a closer range; whereas a 30° spread or beam angle (FIGS. 4b and 5b) allows for suitable illumination of a narrower field, a higher illumination intensity, and/or a longer range. The illuminator 10 is preferably configured and installed with the pivot axes of the hinged connections between the faceplates generally vertically oriented, such that angular adjustment of the faceplates varies the horizontal spread of illumination. Alternatively, the angular orientation of the faceplate adjustment axes may vary depending on the desired application.

In example embodiments, the faceplate position adjustment mechanism 60 comprises a pin 62 or other member slidably coupled within a slot formed in the mounting plate 70, and one or more linkages pivotally connected to the outer faceplates 31, 33 as seen best in FIGS. 4a and 4b. In such an arrangement, a user can manually move the pin coupling 62 forwards and backwards in a slot 72 in the mounting plate 70 to vary the output illumination beam angle. The slot 72 is generally positioned perpendicular to the fixed faceplate 32. The pin coupling 62 is pivotally coupled to elongated linkage members 63, 64, which in turn are pivotally coupled to yokes 65, 66 on each of the adjustable outer faceplates 31, 33. In this manner, sliding the pin coupling 62 rearward in the slot (FIG. 4b), away from the front of the illuminator, rotates the outer faceplates 31, 33 outwards, thereby decreasing the illumination beam angle of the infrared field. Conversely, sliding the pin coupling 62 forward in the slot (FIG. 4a), towards the front of the illuminator 10, pivots the outer faceplates inwards, thereby increasing illumination beam angle of the infrared field. In example embodiments, a screwdriver slot 80 is provided through the housing for manually operating the adjustment mechanism 60. In other embodiments, a motorized or solenoid operated actuator is provided with a local or remote switch or controller, or various other manual or automatic adjustment mechanisms are provided to permit adjustment of the angle of illumination. The screwdriver slot 80, or other means of adjustment is preferably indexed and labeled to permit a user to accurately adjust the illumination angle to a desired setting. In example embodiments, 30°, 45° and 60° field angle settings are provided, and are marked with setting indicia. In various alternate forms of the invention the outer faceplates can be adjusted to any angular orientation between aligned with the control faceplate (0°) and perpendicular to the central faceplate (90°) in the forward and/or backward direction.

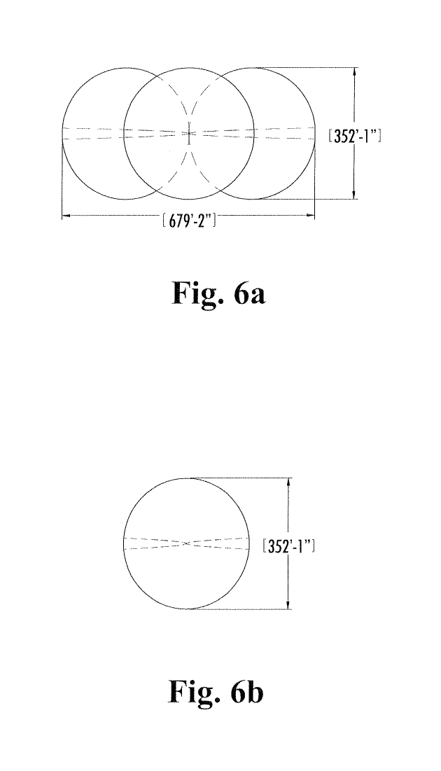

FIGS. 6a and 6b show example patterns of illumination output at 200 meters from the illuminator 10 at 60° (FIGS. 6a) and 30° (FIG. 6b) illumination angles. The 30° adjustment provides for a narrower beam or field (about 352 feet in diameter), but a higher intensity or greater range; while the 60° adjustment allows for a wider beam or field (about 679 feet wide by about 352 feet high), but a lower intensity or shorter range. Similar light distribution patterns result when the beams are examined at different ranges. For example, at 100 meters, example heights of the beams are approximately 176 feet, and example widths of the beam are approximately 339 feet at the 60° adjustment and approximately 176 feet at the 30° adjustment.

In order to dissipate heat generated by the LEDs 22 and the electronic circuitry, one or more (four are depicted) fans 50, 52, 53, and 54 are used to circulate cooling air through the housing to remove heat from the illuminator 10. Three fans (52, 53, 54) are positioned behind the faceplates to blow cool air over and across the LED leads. In example embodiments, each faceplate 30 has at least one fan attached to and positioned behind the faceplate. In alternate embodiments, more or fewer fans 50 are used in differing patterns. These fans are preferably oriented at about 30°-45° angles relative to the faceplates to provide a distributed airflow pattern. For example, fan 53 can be mounted at the top of the center faceplate 32, and angled downwardly at about 45°, and fans 52 and 54 mounted to the middle of side faceplates 31, 33, and angled inwardly at about 30°. In addition to the faceplate fans, at least one larger intake or discharge fan 50 is preferably positioned adjacent an opening through the housing 40, and preferably mounted to the mounting plate 70, to draw in fresh air from outside the housing 40 or to exhaust hot air out of the housing. In the depicted embodiment, fresh air intake A is delivered through one or more openings in a forward portion of the housing 40 beneath or in front of the LED faceplates, and hot exhaust air B is discharged through one or more openings in a rearward portion of the housing 40 behind the LED faceplates. In this manner, the fan(s) circulate air across the front and rear surfaces of the LED faceplates, and between adjacent LEDs for cooling. In alternate forms of the invention, one or more openings or vents are optionally provided through the faceplates for allowing fresh air to be draw in through the faceplates.

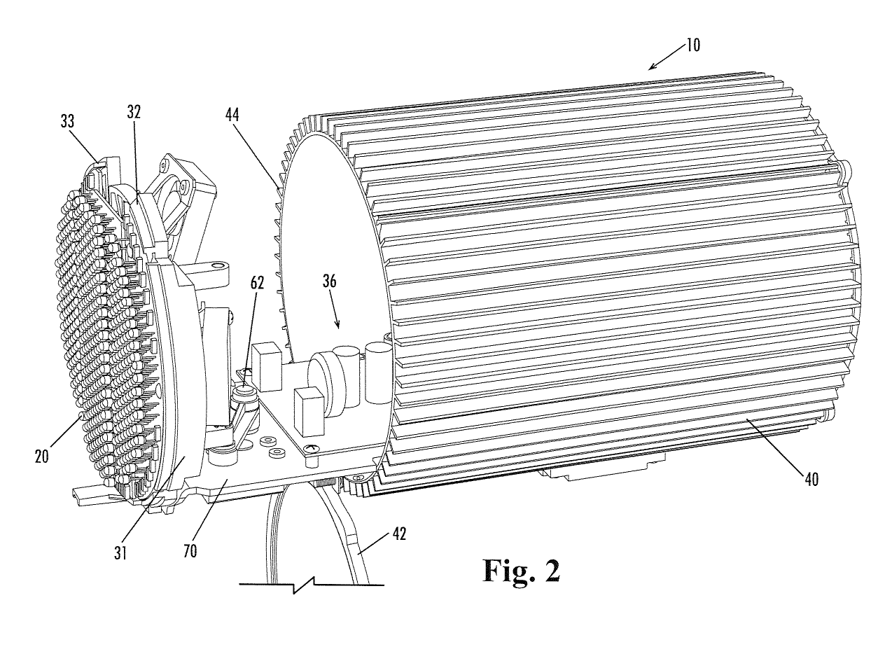

In example embodiments, the housing 40 is generally cylindrical in shape and adapted to receive the LEDs 22, faceplates, fans 50, and accompanying electrical components therein in a weatherproof enclosure. The housing 40 can be fabricated from various materials including, but not limited to, metal, plastic, rubber, or a combination thereof. In order to further cool the illuminator, the housing 40 optionally includes ridges or fins 44 for dissipating internal heat through convection with the surrounding air. In alternate embodiments, the shape of the housing is conical, rectangular, spherical or cubic, or otherwise configured. The housing 40 preferably comprises a clear glass or plastic lens 42 mounted within a front cover portion of the housing for protecting and transmitting light from the LEDs, and/or to allow a user to focus the infrared light output. The front cover portion of the housing is preferably removable for access to internal components, as seen in FIG. 2.

In embodiments having a circular housing cross-section, the fixed faceplate and the one or more outer faceplates preferably combine to have a generally circular outer profile sized to be closely received within the outer housing. For example, each of the outer faceplates in the depicted embodiment have profiles in the form of a circular segment divided from the fixed center faceplate by two parallel chords spaced equidistant from the central vertical diameter of the overall circular faceplate array. In alternate embodiments, a generally square or rectangular overall faceplate array comprising two or more rectangular faceplates are received within a housing having a generally square or rectangular cross-section. In example forms of the invention, each faceplate has approximately equal width and/or approximately equal surface area, such that each faceplate may carry about the same number of LEDs.

FIGS. 7 and 8 show another embodiment of an illuminator 10′ according to the present invention, equipped with an onboard infrared camera 90, to capture images under illumination by the illuminator. Signals corresponding to the image are transmitted by cable or wireless connection to a local or remote monitor or viewing station, and/or to a recording device (unshown). In example embodiments, the camera 90 is mounted in an opening 92 formed through the center of the fixed middle faceplate 32, such that the camera's field of view is coaxially aligned with the illuminator's field of illumination. Other components of the illuminator 10′ are substantially like corresponding components of the above described embodiment, and are indicated with corresponding reference numbers with a prime (′) designation.

While the invention has been described with reference to preferred and example embodiments, it will be understood by those skilled in the art that a variety of modifications, additions and deletions are within the scope of the invention, as defined by the following claims.

What is claimed is:

1. An illuminator comprising:
a fixed panel having at least one light source mounted thereon; and
a pivoting panel hingedly connected to the fixed panel and having at least one light source mounted thereon.

2. The illuminator of claim 1, wherein the fixed panel and the pivoting panel are enclosed within a housing.

3. The illuminator of claim 1, wherein the light sources are infrared light sources.

4. The illuminator of claim 3, wherein the infrared light sources are LEDs.

5. The illuminator of claim 1, comprising a first pivoting panel hingedly connected to one side of the fixed panel and having at least one light source mounted thereon, and a second pivoting panel hingedly connected to the other side of the fixed panel and having at least one light source mounted thereon.

6. The illuminator of claim 1, further comprising means for adjusting the angular orientation of the pivoting panel relative to the fixed panel.

7. The illuminator of claim 1, further comprising a camera.

8. The illuminator of claim 7, wherein the camera is mounted within an opening in one of the fixed panel and the pivoting panel.

9. The illuminator of claim 1, further comprising at least one fan for circulating air.

10. The illuminator of claim 9, comprising a first fan attached to the fixed panel and a second fan attached to the pivoting panel.

11. The illuminator of claim 1, further comprising a controller for varying power delivery to the light sources.

12. An infrared illuminator comprising:
a first member having a first infrared light source mounted thereto;
a second member having a second infrared light source mounted thereto, the second member being positionally adjustable relative to the first member; and
a housing containing the first and second members.

13. The infrared illuminator of claim 12, further comprising at least one fan for delivering cooling air within the housing.

14. The infrared illuminator of claim 12, further comprising a positional adjustment mechanism for varying the position of the second member in relation to the first member such that a field of infrared light projected by the first and second infrared light sources can be modified.

15. The infrared illuminator of claim 12, wherein the positional adjustment mechanism varies the position of the second member in relation to the first member to generate illumination beam angles of between 30° and 60°.

16. The infrared illuminator of claim 12, wherein the positional adjustment mechanism comprises a pin-and-slot coupling.

17. The infrared illuminator of claim 12, wherein a slot portion of the pin-and-slot coupling is oriented generally perpendicular to the first member.

18. The infrared illuminator of claim 12, wherein the first member is a fixed panel, the second member is a first pivotal panel hingedly coupled to a first side of the fixed panel, and further comprising a second pivotal panel hingedly coupled to a second side of the fixed panel, the second pivotal panel comprising a third infrared light source.

19. The infrared illuminator of claim 18, wherein the fixed panel and the first and second pivotal panels combine to form a generally circular profile.

20. The infrared illuminator of claim 12, further comprising a switch for varying power delivery to the first and second infrared light sources.

21. The infrared illuminator of claim 12, further comprising a camera.

22. An infrared illuminator comprising:
a housing;
a first panel mounted within said housing and having a first plurality of infrared LEDs mounted thereon; and
a second panel hingedly connected to one side of the first panel and having a second plurality of infrared LEDs mounted thereon.

23. The infrared illuminator of claim 22, further comprising a third panel hingedly connected to the other side of the first panel and having a third plurality of infrared LEDs mounted thereon.

24. The infrared illuminator of claim 22, further comprising a switch for varying power delivery to the first and second pluralities of infrared LEDs.

25. The infrared illuminator of claim 22, further comprising a camera.
